(19) United States
(12) Patent Application Publication
(10) Pub. No.: US 2009/0160725 A1
(43) Pub. Date: Jun. 25, 2009

(54) Co-located transmit-receive antenna system

(76) Inventors: Mark Rhodes, West Lothian (GB); Brendan Hyland, Edinburgh (GB)

Correspondence Address: Goodwin Procter LLP;Attn: Patent Administrator, 135 Commonwealth Drive, Menlo Park, CA, 94025-1105, US

(21) Appl. No.: 12/338,002

(22) Filed: Dec. 18, 2008

Related U.S. Application Data
(60) Provisional application No. 61/014,795, filed on Dec. 19, 2007.

(30) Foreign Application Priority Data
Dec. 19, 2007 (GB) 0724703.4

(51) Int. Cl. H01Q 21/00

(52) U.S. Cl. 343/867

(57) ABSTRACT

A transceiver antenna system comprising at least one solenoid receive antenna and at least one transmitting loop antenna, the at least one solenoid receive antenna being located with its axis in the plane of a transmitting loop antenna and located inside the loop.

### CROSS-REFERENCE TO RELATED APPLICATIONS

This application claims the benefit of U.S. Ser. No. 61/014,795 filed Dec. 19, 2007 and GB 0724703.4 flied Dec. 19, 2007, both of which applications are fully incorporated herein by reference.

### INTRODUCTION

The present invention relates to the design of a co-located antenna system, which is simultaneously optimised for transmit and receive performance.

### BACKGROUND

Low frequency radio applications below 100 MHz often beneficially employ loop or solenoid antenna designs as a means of achieving a physically small antenna particularly for portable applications. Receive functionality is optimally achieved with a solenoid of maximum practical length to diameter ratio wound around a high magnetic permeability core. Ferrite materials are often selected for the receiver core due to their high magnetic permeability at low magnetic field strengths. However, permeability is reduced and the induced magnetic flux saturates as field strength increases and for this reason ferrite cores are not beneficial in efficient transmit antenna designs. Design considerations typically lead to the selection of an open cored loop with maximum practical radius as an optimal transmitter design. These very different requirements present a problem when implementing co-located receive and transmit antennas which is a common requirement for two way communications systems and other applications.

Antenna efficiency of a small loop or solenoid can be broadly represented in terms of its magnetic moment. Magnetic moment is directly proportional to each of three parameters: loop area, loop current, and number of loop turns. Equivalently, it may be stated that the magnetic moment is proportional to both the ampere-turn product of the loop and to the area of the loop. For signal detection at greatest distance, the largest achievable magnetic moment is desirable. Thus, it is usually desirable that as many as possible of the three partially related parameters are designed to be as large as practical circumstances will permit. Area and effective magnetic permeability play similar roles in the radio link equations. An efficient antenna would ideally be wound around a high permeability core material. This can be practically realised for a receive antenna function but for transmit practical high permeability materials such as ferrites exhibit saturation characteristics which lower their effective permeability at high magnetic field strengths. For this reason the two functions diverge.

### SUMMARY OF INVENTION

According to one aspect of the present invention, there is provided a transmit-receive antenna that has a receive solenoid antenna and transmit loop antenna co-located to allow optimised operation in both transmit and receive modes.

For transmit a high magnetic moment is achieved by neglecting permeability and using an open core to implement the maximum practical area in any given deployment. For receive the relative advantage of high permeability core can be fully realised without any saturation effects.

According to another aspect of the present invention, the benefits of receive solenoid design and transmit open core loop are simultaneously implemented in a compact structure.

According to another aspect of the present invention, there is provided a combined transmit-receive antenna system wherein a solenoid receive antenna is located with its axis in the plane of a transmitting loop antenna.

This arrangement is particularly advantageous for systems, which aim to operate receive and transmit simultaneously or in close time division systems. The geometric arrangement of the antennas beneficially reduces the signal generated in the solenoid receiver signal during transmit. Practically, the degree to which the solenoid can be isolated from the transmit signal will be limited by the accuracy of the mechanical alignment and construction of the solenoid and loop.

### BRIEF DESCRIPTION OF THE DRAWINGS

Various aspects of the invention will now be described by way of example only and with reference to the accompanying drawings, of which:

FIG. 1 shows the geometrical alignment of receive solenoid and transmit loop;

FIG. 2 shows the transmit to receive isolation achieved by alignment of the receive solenoid axis in the plane of the transmit loop;

FIG. 3 shows a transceiver antenna system that employs two receive solenoids in the plane of the transmit loop;

FIG. 4 shows a receive solenoid arranged along the X axis in the plane of a transmit loop deployed in the XY plane;

FIG. 5 shows the relative alignment of a pair of transceiver antennas arranged for two-way communications;

FIG. 6 shows a system arrangement for driving multiple transmit loops;

FIG. 7 shows a system for receiving signals from multiple receive antennas.

### DETAILED DESCRIPTION OF THE DRAWINGS

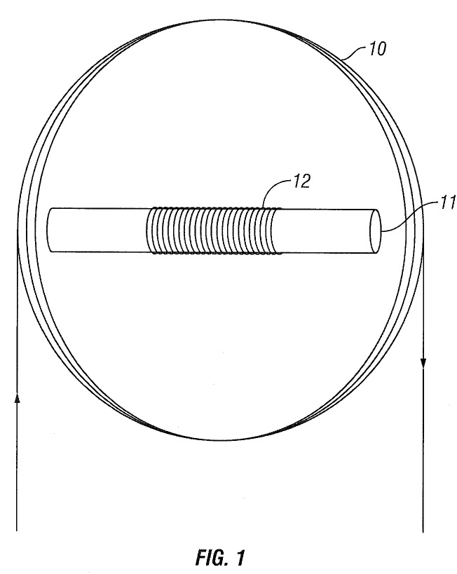

FIG. 1 shows the geometrical alignment of receive solenoid 12 and transmit loop 10. Receive solenoid is represented by the wires shown in section 12. Multiple turns of wire form receive solenoid 12 wound around high magnetic permeability core 11. Transmit loop 10 is constructed with a diameter that exceeds the solenoid core's 11 length. Solenoid 12 is arranged with its axis in the plane of the transmit loop 10 and is beneficially disposed with its centre substantially co-incident with the loop's centre. Solenoid 12 is wound in contact with the surface of core 11. Solenoid 12 should have a diameter that is less than half the loop's radius to limit the volume of core material that is enclosed by the loop. Multi-turn transmit loop 10 generates lines of flux coming out of the page so does not saturate receive coil 12.

Receive coil 12 and core 11 are designed by selection of permeability, length to diameter ratio, number of turns and position of turns on the rod using principles well known to practitioners skilled in the art of low frequency radio antenna design and will not be repeated here since the design decisions are un-modified by the mechanical arrangement which is the present subject of this invention. Similarly the number of turns used in the transmitting loop will be selected dependent on the available driving Voltage and the material of the wire loop to maximise the current-turns product at the desired frequency of operation.

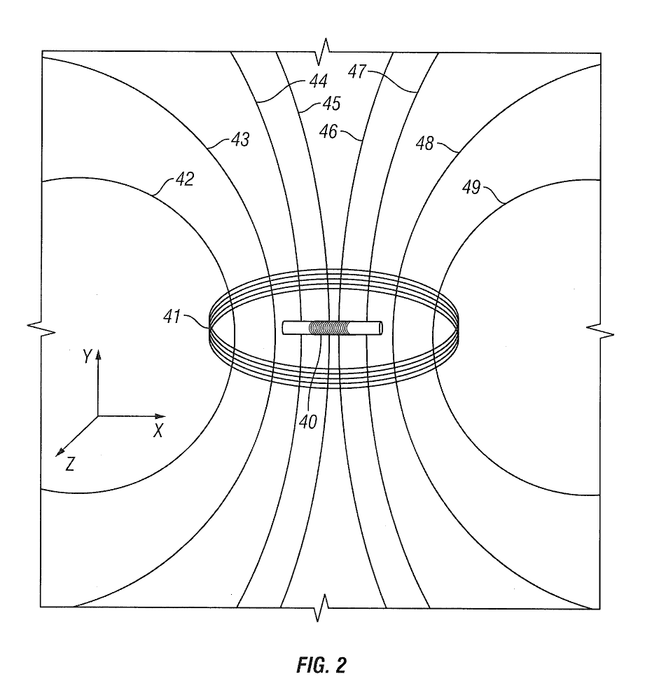

FIG. 2 shows the transmit to receive isolation achieved by alignment of the receive solenoid axis in the plane of the transmit loop 41. Receive solenoid 40 is shown with its axis aligned with the X axis. Transmit loop 41 is positioned in the XZ plane. A current flowing in transmit loop 41 generates magnetic flux illustrated by lines 42 to 49. Flux is generated perpendicular to the transmit loop plane where they intersect the plane. Magnetic flux vectors are aligned with the Y axis where they interest the XZ plane within the transmit loop. A receive solenoid 40 aligned in the transmit plane as illustrated has lines of flux perpendicular to its axis. Voltage is induced in a solenoid only by the magnetic flux vector component, which is parallel to its axis, in this case the X component of magnetic flux. Solenoid 40 is manipulated in X, Y, Z position and angular alignment with respect to the transmit loop until transmit to receive isolation is maximised. The null point of maximum isolation exists over a narrow angular range so accurate alignment using this method is beneficial for optimising isolation.

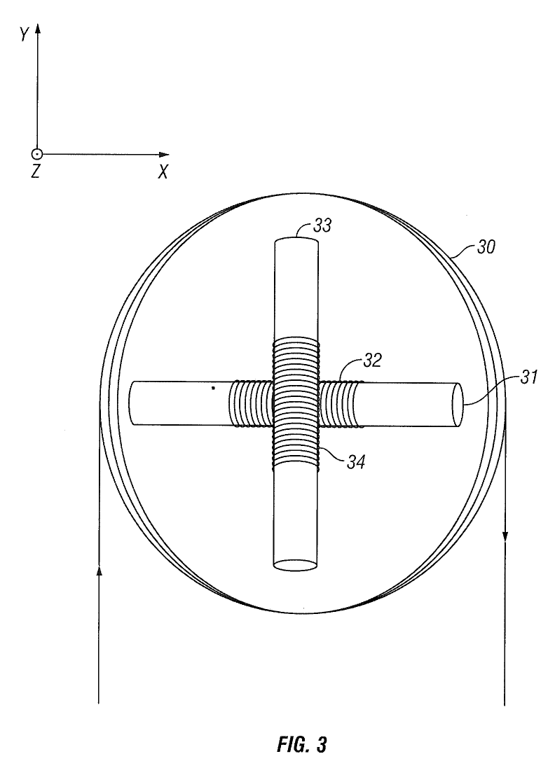

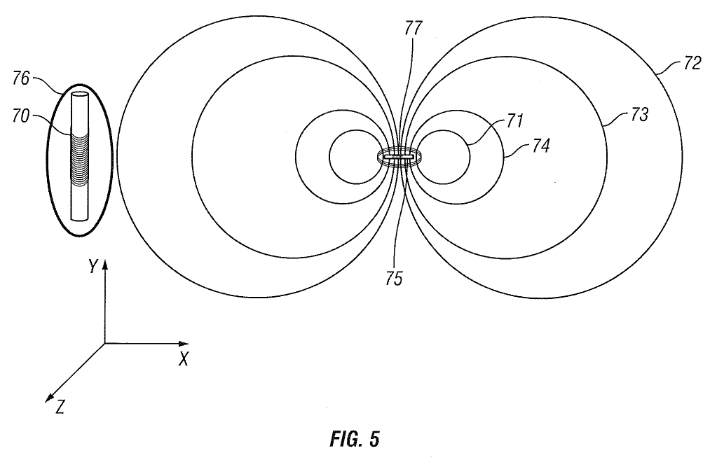

FIG. 3 shows a transceiver antenna system that employs two receive solenoids 32 and 34 in the plane of the transmit loop 30. Solenoids 32 and 34 and their associated cores 31 and 33 will typically be of substantially identical construction. Loop 30 carries a current to induce transmitted magnetic flux. Solenoid 32 is wound around core 31 and solenoid 34 is wound around core 33. Cores 31 and 33 are shorter than transmit loop 30 diameter and are placed within loop 30. Both receive solenoids 31 and 33 are isolated from the transmit signal since solenoids are isolated for any angular rotation within the transmit loop plane. Solenoids produce an induced voltage proportional to the component of magnetic flux that is parallel to their axis. The arrangement shown aligns solenoid 32 with the X axis and solenoid 34 with the Y axis to maximise reception of X and Y components of incident magnetic flux from a remote source as shown in FIG. 5. Transmit to receive isolation is maximised when the solenoid axis is in the plane of the loop. In the two solenoid arrangement illustrated the solenoids intersect at the centre of the loop. To maintain transmit to receive isolation the solenoid axes must be either be offset from the plane by the diameter of the solenoids so allowing both solenoids to be centred on the loop or solenoid cores 31 and 33 can be shortened so they do not intersect.

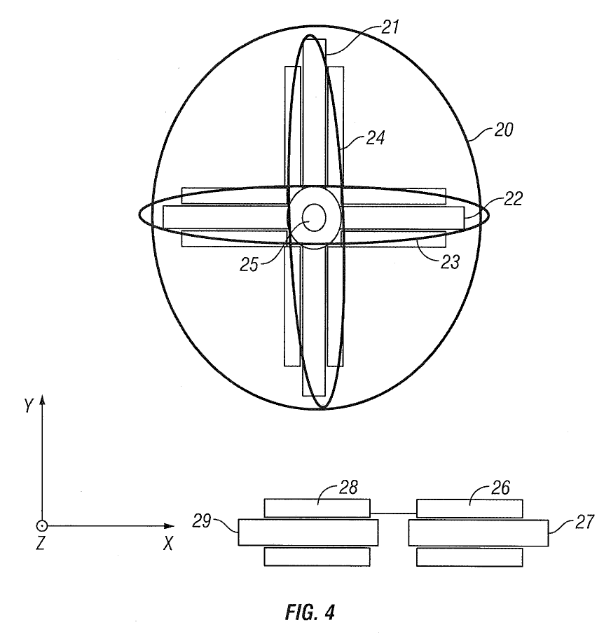

FIG. 4 shows a further development of the present invention. Receive solenoid 22 is arranged along the X-axis in the plane of transmit loop 20 deployed in the XY plane. Receive solenoid 21 is arranged along the Y-axis and has a similar relationship to transmit loop 20. A third receive solenoid 25 is arranged along the Z axis and further transmit loops 23 and 24 arranged in the ZX and ZY planes respectively. This structure allows antenna diversity to achieve optimal performance in any of the three dimensions. The structure can be thought of in terms of three mutually orthogonal transceiver structures as represented in FIG. 1. Each of these transceiver pairs can be selected for independent use based on received signal strength. Alternatively signals from each antenna can be preferentially combined through adaptive phase control of each signal path to maximise their combined magnitude. In a similar fashion transmit signals can be supplied with controlled relative phase to preferentially modify the radiation pattern.

The three dimensional structure of FIG. 4 presents the issue of solenoid cores intersecting at the centre of the structure as seen in FIG. 3. While in FIG. 3 we are able to consider arranging the cores so they do not intersect in this three dimensional arrangement this is not desirable since this would place one of the cores outside of the plane of its corresponding transmit loop and hence significantly reduce transmit to receive isolation. The reduction in isolation can be acceptable in some applications. Where higher isolation is required cores 21, 22 and 25 may be split into two halves either side of the central intersecting region to allow all three axes to intersect at the centre while the cores do not intersect. This arrangement is shown by cores 27 and 29 arranged on a common axis and wound with solenoids 26 and 28 respectively. Solenoids 26 and 28 are connected in series.

FIG. 5 shows the relative alignment of a pair of transceiver antennas arranged for two way communications. Transmit loop 77 is arranged in the XZ plane and a current flowing in the loop generates magnetic flux lines 71, 72, 73 and 74. Receive solenoid 70 is aligned with the Y axis for optimum reception of the illustrated magnetic flux. Transmit loop 76 is arranged in the YZ plane and receive solenoid 75 is aligned with the X axis for optimum reception of flux generated by transmit loop 76. Solenoid 75 is isolated from the local transmitter 77 and solenoid 70 is isolated from local transmit loop 76.

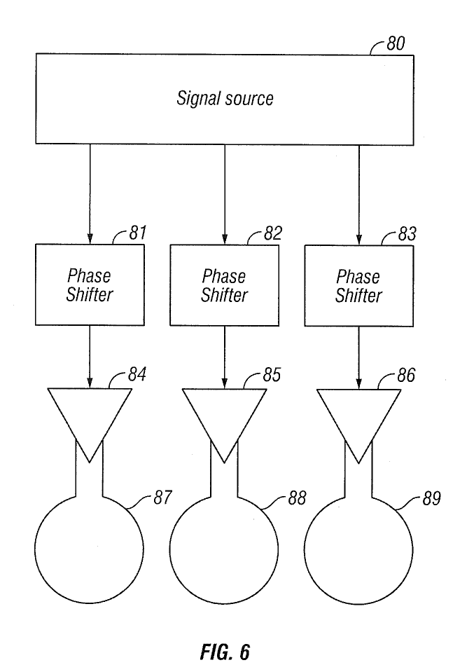

FIG. 6 shows a system arrangement for driving multiple transmit loops. This system will be suitable for the multiple axis antenna system shown in preceding figures. In one example, implementation antennas 87, 88 and 89 may be arranged in mutually orthogonal planes as illustrated in FIG. 4. Signal source 80 generates the desired transmit waveform which in some systems may comprise a modulated communications waveform. The signal is supplied to phase shifting devices 81, 82 and 83. Power amplifiers 84, 85 and 86 amplify the signal and supply low impedance high current drive to loop antennas 87, 88 and 89.

The relative phase of each signal can be adjusted. This will result in a modification of the resulting field pattern, which is generated by vector addition of the magnetic flux generated by each loop. The ability to control relative phase will allow steering of maximum signal strength toward an intended target for example a receiver. This system also allows control of the angular alignment of a null position to enable transmission of a reduced magnetic flux toward a target location. This capability opens up the possibility of special diversity where adjacent transceiver systems simultaneously make use of a common frequency band but are isolated by directing the signal away from neighbouring systems. An additional control mechanism can be achieved by using amplifiers 87, 88 and 89 to implement gain control. In this way a single antenna may be used to transmit flux in a desired angular orientation or the relative contribution from each of the three axis antennas may be tailored.

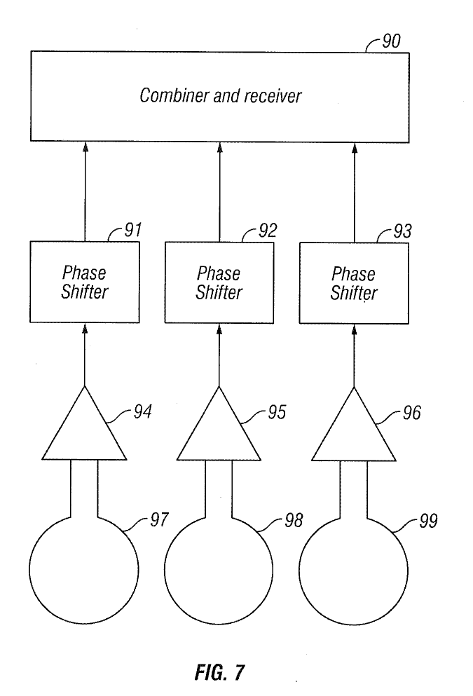

FIG. 7 shows a system for receiving signals from multiple receive antennas. This system is suitable for the multiple axis antenna system shown in preceding figures. In one example, implementation antennas 97, 98 and 99 may be arranged in mutually orthogonal axes as illustrated in FIG. 4. Antennas 97, 98 and 99 receive an induced voltage that is amplified by receive amplifiers 94, 95 and 96. Each of the three channels is fed to a phase shifter 91, 92 and 93. Combiner and receiver 90 integrates the three channels for use by a transceiver system application. Phase shifters 91, 92 and 93 can be independently controlled to adjust the composite beam pattern that results from vector addition of the signals received by each of the receive antennas. Amplifiers 94, 95 and 96 also provide independent gain control which can be used to select the input from a single antenna to implement antenna diversity or to adjust the relative amplitude of the contribution of each signal to a summed signal hence modifying the receive antenna gain pattern.

A skilled person will appreciate that variations of the disclosed arrangements are possible without departing from the invention. For example, while this disclosure has used ferrite as an example core material for the receive antenna other high permeability materials may be preferable in specific design implementations. Accordingly the above description of the specific embodiment is made by way of example only and not for the purposes of limitation. It will be clear to the skilled person that minor modifications may be made without significant changes to the operation described.

1. A transceiver antenna system comprising at least one solenoid receive antenna and at least one transmitting loop antenna, the at least one solenoid receive antenna being located with its axis in the plane of a transmitting loop antenna and located inside the loop.

2. An antenna as claimed in claim 1 wherein the solenoid receive antenna is formed around a core material with an initial relative magnetic permeability of greater than 100.

3. An antenna as claimed in claim 1 wherein the transmitting loop antenna has an open core.

4. An antenna as claimed in claim 1 wherein the at least one receive solenoid is arranged with its axis in the plane of a transmitting loop.

5. An antenna as claimed in claim 1 wherein two or more receive solenoids are arranged with their axes in the plane of a transmitting loop.

6. An antenna as claimed in claim 1 wherein two or more receive solenoids are arranged with their axes in the plane of a transmitting loop and at least two of the solenoid axes are mutually orthogonal.

7. An antenna as claimed in claim 1 wherein three receive solenoids are provided, the three solenoids being arranged with mutually orthogonal axes intersecting at a common point.

8. An antenna as claimed in claim 1 wherein one or more pairs of solenoids are provided, the solenoids of a pair being arranged about a common axis and connected in series.

9. An antenna as claimed in claim 1 wherein three pairs of solenoids are provided, the solenoids of each pair being arranged about a common axis and connected in series, and each pair being arranged relative to the other pairs with mutually orthogonal axes intersecting at a common point.

10. An antenna as claimed in claim 1, wherein multiple transmit loops are provided.

11. An antenna as claimed in claim 1 wherein three transmit loops are provided, the loops being arranged in mutually orthogonal planes intersecting at a common point.

12. An antenna as claimed in claim 1 wherein three transmit loops are arranged in mutually orthogonal planes intersecting at a common point and three receive solenoids are arranged in mutually orthogonal axes intersecting at the same common point and each solenoid arranged in the plane of a transmit loop.

13. An antenna as claimed in claim 1 comprising means for varying the relative phase and/or gain of each antenna.

14. An antenna as claimed in claim 1 comprising means for varying the relative phase and/or gain of each antenna, wherein the means for varying are operable to independently vary the relative phase and/or gain of each antenna.

15. A method for aligning at least one solenoid receive antenna and at least one transmitting loop antenna, the at least one solenoid receive antenna being located with its axis in the plane of a transmitting loop antenna, the method comprising adjusting the relative position and angular alignment of the receive solenoid and the transmit loop; monitoring voltage induced across the receive solenoid while a signal is applied to the transmit loop and selecting the position at which the induced voltage is substantially minimised.

16. A method for transmitting a signal using an antenna system as claimed in claim 1 where multiple transmit loops are provided, the method comprising controlling the relative phase and or amplitude of the transmit signals applied to each transmit loop.

17. A method for receiving a signal using an antenna system as claimed in any of claims 1 where multiple receive solenoids are provided, the method comprising controlling the relative phase and or amplitude of received signals.

18. A method as claimed in claim 17 wherein the relative phase and or amplitude of the received signals is controlled so as to produce a null in a desired angular direction.

19. A method as claimed in claim 17 wherein the relative phase and or amplitude of the received signals is controlled to produce an antenna gain maxima in a desired angular direction.
